(19) United States
(12) Patent Application Publication
(10) Pub. No.: US 2025/0147635 A1
(43) Pub. Date: May 8, 2025

(54) PLACEMENT OF GRAPHICAL ELEMENTS ON ARBITRARY DISPLAY SURFACES FOR IN-CAMERA VISUAL EFFECTS

(71) Applicant: Lucasfilm Entertainment Company Ltd. LLC, San Francisco, CA (US)

(72) Inventors: Alan Lionel Joseph BUCIOR, Vancouver (CA); David Charles HIRSCHFIELD, San Francisco, CA (US); Michael Justin Lee JUTAN, Kentfield, CA (US); Ahmed TURKI, London (GB)

(21) Appl. No.: 18/500,972

(22) Filed: Nov. 2, 2023

(51) Int. Cl. G06F 3/04815; G06F 3/0482; G06F 3/0488; G06T 11/60

(52) U.S. Cl. CPC G06F 3/04815; G06F 3/0482; G06F 3/0488; G06T 11/60

(57) ABSTRACT

One embodiment of the present invention sets forth a technique for placing graphical elements on display surfaces. The technique includes generating a first visualization of a first display surface based on a first two-dimensional (2D) parameterization of the first display surface. The technique also includes receiving a first user input that specifies a first location within the first visualization and converting the first location into a second location within the first 2D parameterization. The technique further includes causing a first graphical element to be displayed at a third location on the first display surface based on the second location and displaying, within the first visualization, a first representation of the first graphical element at the first location.

### BACKGROUND

### Field of the Various Embodiments

Embodiments of the present disclosure relate generally to in-camera visual effects and, more specifically, to flexible parameterization of arbitrary display surfaces for in-camera visual effects.

### Description of the Related Art

In-camera visual effects refer to visual effects captured in real-time during the shooting of a media production, such as movie or television show. In-camera visual effects are typically achieved using various elements such as light cards, display surfaces, etc. Light cards are virtual lights that can take on various lighting related attributes for the purpose of lighting a subject within a performance stage. Precise placement of light cards and other similar elements using current systems, however, is frequently difficult, counterintuitive and may lead to undesirable results.

As such, what is needed in the art are more effective techniques for placing elements, such as light cards, for in-camera visual effects.

### SUMMARY

One embodiment of the present invention sets forth a technique for generating three-dimensional (3D) graphics. The technique includes matching a layout of a plurality of display surfaces within a 3D space to a plurality of mappings between the plurality of display surfaces and a plurality of two-dimensional (2D) regions. The technique also includes determining (i) a first location of a first graphical element within a first region included in the plurality of 2D regions and (ii) a first mapping that is associated with the first region and included in the plurality of mappings. The technique further includes converting the first location into a first set of spatial attributes associated with the plurality of display surfaces based on the first mapping, and causing the first graphical element to be displayed in a first display surface included in the plurality of display surfaces based on the first set of spatial attributes.

One technical advantage of the disclosed techniques is the ability to subdivide and parameterize arbitrary numbers and arrangements of display surfaces within a 3D space into a number of discrete 2D regions. Accordingly, the disclosed techniques allow locations of graphical elements on the display surfaces to be specified in a precise and unambiguous manner. Another technical advantage of the disclosed techniques is the ability to select and update display surfaces on which the graphical elements are to be shown and locations of the graphical elements within the display surfaces via a WYSIWYG user interface. Consequently, the disclosed techniques can be used to generate in-camera visual effects and/or other types of 3D graphics more quickly, efficiently, and accurately than user interfaces that include counterintuitive abstractions of dimensions within a 3D space. These technical advantages provide one or more technological improvements over prior art approaches.

### BRIEF DESCRIPTION OF THE DRAWINGS

The patent or application file contains at least one drawing executed in color. Copies of this patent or patent application publication with color drawings will be provided by the Office upon request and payment of the necessary fee.

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an immersive content production system, according to various embodiments.

FIG. 2 illustrates a computer system configured to implement one or more aspects of the various embodiments.

FIG. 3 is a more detailed illustration of the user interface and placement engine of FIG. 2, according to various embodiments.

FIG. 4A illustrates an example layout visualization provided by the user interface of FIG. 2, according to various embodiments.

FIG. 4B illustrates an example screenshot of a placement tool provided by the user interface of FIG. 2, according to various embodiments.

FIG. 4C illustrates an example screenshot of a placement tool provided by the user interface of FIG. 2, according to various embodiments.

FIG. 4D illustrates an example screenshot of a placement tool provided by the user interface of FIG. 2, according to various embodiments.

FIG. 5 sets forth a flow diagram of method steps for generating in-camera effects using parameterizations of display surfaces, according to various embodiments.

FIG. 6 sets forth a flow diagram of method steps for placing graphical elements on display surfaces via a user interface, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

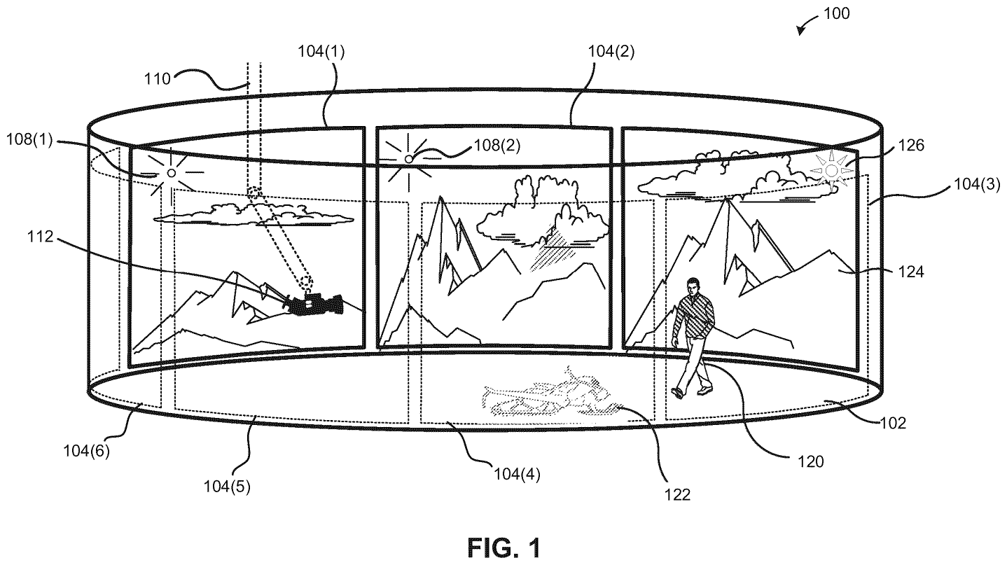

FIG. 1 illustrates an immersive content production system 100, according to various embodiments. As shown, system 100 includes, without limitation, a performance area 102 that includes and/or is partially or completely surrounded by displays 104(1)-104(6) (each of which is referred to individually herein as displays 104). Immersive content production system 100 can use displays 104 to display virtual content such as images, video, and/or graphical elements.

Performance area 102 can include (but is not limited to) a movie or television set, a sound stage, a stadium, a park, or the like. In some embodiments, immersive content production system 100 uses displays 104 to present images in real-time and/or at interactive frame rates to users of immersive content production system 100 (e.g., performers within performance area 102), thereby creating an immersive environment (also referred to as an immersive “volume”) for performances that take place within performance area 102.

In some embodiments, displays 104 include light emitting diode (LED) display screens and/or liquid crystal display (LCD) display screens. For example, performance area 102 can include one or more walls of LED or LCD displays 104. Displays 104 can also, or instead, include projector screens onto which images and/or other content is projected by one or more corresponding projectors.

Displays 104 and performance area 102 can include various sizes and/or dimensions. For example, displays 104 could be 20-40 feet tall, and performance area 102 could be between 50-100 feet in diameter. One or more displays 104 could be in substantially fixed positions and mostly surround performance area 102. One or more displays 104 could also, or instead, include mobile displays 104 (e.g., sliding doors) that can be moved into positions to create an immersive environment that extends completely or almost completely (around performance area 102. For example, fixed position displays 104 could extend approximately 270 degrees around performance area 102, while movable displays 104 could augment the fixed position displays to further extend the immersive environment up to 320-360 around the performance area.

Additionally, while not shown in FIG. 1, in some embodiments, the immersive content production system 100 can further include one or more displays 104 that form a ceiling on the performance area 102 and/or a part of the floor of performance area 102. Also, while adjacent displays 104 in FIG. 1 are separated by small spaces or gaps, displays 104 can be installed to be seamless, with less than a threshold distance or no perceptible distance between adjacent displays 104. Within performance area 102, displays 104 can be formed and/or arranged into flat, curved, conical, spherical, and/or other shapes or topologies.

A taking camera 112 can be attached to a rig 110 inside performance area 102 to capture the performance of a performer 120 within performance area 102 and at least a portion of a virtual environment (e.g., the background for a scene in which the performance occurs) displayed on displays 104. In some embodiments, sensors are used to determine the position and orientation of the taking camera 112 during a performance. For example, Global Positioning System (GPS) sensors, accelerometers, gyroscopes, magnetometers, and/or other types of sensors can be attached to taking camera 112 to determine the position and/or orientation of taking camera 112 within or relative to the performance area 102.

In some embodiments, other cameras (e.g., motion capture cameras, alignment cameras, etc.) can be directed at taking camera 112 and/or configured to capture the performance. One or more markers can be attached to taking camera 112, and the other cameras can capture images of taking camera 112 and/or the marker(s) as taking camera 112 is moved and oriented during the performance. Immersive content production system 100 can use the captured images of taking camera 112 and/or the marker(s) to determine the movement and orientation of taking camera 112 during the performance. This information can then be used to support the content production process. For example, information regarding the orientation and movement of taking camera 112 could be used to determine the distance of taking camera 112 from performer 120 during a performance. This information (as well as other intrinsic attributes such as lens aperture and focal length) could additionally be used by immersive content production system 100 to adjust the virtual environment depicted in displays 104 in real-time and/or at interactive frame rates, so that the perspective associated with the virtual environment can be updated with respect to the view captured by taking camera 112.

In some embodiments, the immersive volume includes one or more lighting elements to provide lighting for performance area 102. For example, the immersive cave or walls could include supplemental light emitting diode (LED) lights (not shown), which are separate from displays 104 and can used to create various desired lighting effects within performance area 102. These LED lights could be configured to project at different colors, intensities, and/or locations around performance area 102. These LED lights could thus be used to control lighting of performance area 102 (including performer 120) during a performance.

In some embodiments, additional lighting elements can be created within one or more portions of displays 104 that create the virtual environment. For example, instead of depicting the virtual environment in a portion of one or more of displays 104 surrounding the performance area, that portion of the display 104 could be used to simulate an LED light that illuminates performance area 102. In this regard, immersive content production system 100 can include multiple simulated lights 108(1)-108 (2) (each of which is referred to individually herein as simulated light 108). The location and/or visual attributes (e.g., color, intensity, etc.) of each simulated light 108 on displays 104 could be varied to achieve a desired lighting effect. This control of simulated lights 108 can be performed by a director, lighting technician, and/or another user of immersive content production system 100, prior to and/or during a performance in performance area 102. The number, location, and/or visual attributes of simulated lights 108 can also be adjusted at any time during the performance.

In some embodiments, simulated lights 108 are also referred to as “light cards” or “virtual lights.” These simulated lights 108 can be employed in addition to or in lieu of the supplemental lights. For example, immersive content production system 100 could use simulated lights 108 in lieu of or in addition to supplemental lights.

In some embodiments, immersive content production system 100 includes one or more depth sensors and/or one or more alignment cameras (not shown in FIG. 1). Alignment cameras, also referred to as motion cameras, can capture motion in performance area 102. During a performance, immersive content production system 100 can use the alignment cameras to detect motion, positions, and/or orientations of performer 120 within performance area 102. The detection can be based on markers or sensors worn by performer 120, the alignment cameras, and/or other components or techniques.

An array of depth sensors can also, or instead, be positioned in proximity to and directed at performance area 102. For example, the depth sensors could be disposed along the perimeter of the performance area for the purpose of measuring the depth of different parts of performer 120 in performance area 102 during a performance. This depth information can then be stored and used by immersive content production system 100 to further determine and/or calibrate the positions, orientations, and/or movements of performer 120 over the course of the performance.

The depth sensors can include a motion-sensing input device, such as a monochrome complementary metal-oxide semiconductor (CMOS) sensor and an infrared projector. The infrared projector can project infrared light throughout performance area 102, and the CMOS sensor can measure the distance of each point of reflected infrared (IR) radiation in performance area 102 by measuring a time it takes for the emitted infrared light to return to the CMOS sensor. Software in the depth sensors can process the IR information received from the depth sensors and use a computer vision and/or machine learning technique to map the visual data and create three-dimensional (3D) depth models of solid objects in performance area 102, such as (but not limited to) performer 120, a floor, a ceiling, one or more walls, a ceiling, and/or one or more physical props 122.

As shown in FIG. 1, performance area 102 includes one or more physical props 122 (e.g., a snowmobile), which are combined with scenery images 124 of a virtual environment presented on displays 104 to generate the immersive environment within which performer 120 conducts a performance. For example, props 122 could be placed in the immediate vicinity of performer 120 to allow performer 120 to interact and/or move within or around props 122 during a scene in a media production. As performer 120 acts out the scene, scenery images 124 could be updated on displays 104 to reflect changes in location, perspective, time, weather, events, and/or other attributes associated with the environment depicted in the scene.

In some embodiments, scenery images 124 can be seamlessly presented across several displays 104. Scenery images 124 can include one or more virtual light sources 126, such as (but not limited to) an image of a sun, a moon, stars, streetlights, and/or other natural or manmade light sources in the virtual environment depicted on displays 104.

Embodiments of the invention can generate and display perspective-correct images (as rendered from the tracked position and perspective of taking camera 112) onto portions of the surrounding image display walls that are within the field of view (i.e., the frustum) of the taking camera. In some embodiments, areas of displays 104 outside the field of view of taking camera 112 can be displayed according to a global view perspective.

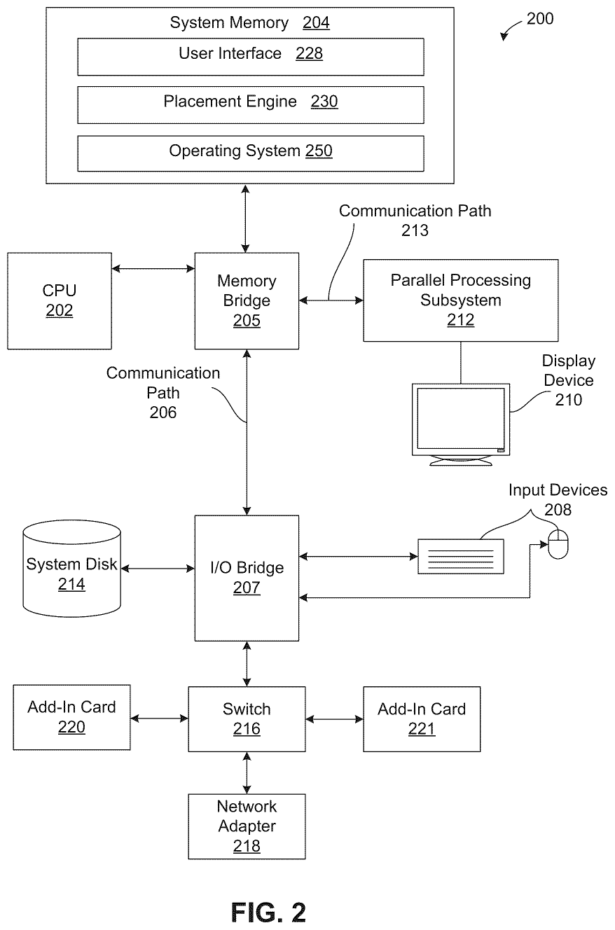

FIG. 2 illustrates a computer system 200 configured to implement one or more aspects of the various embodiments. In some embodiments, computer system 200 is a machine or processing node operating in a data center, cluster, or cloud computing environment that provides scalable computing resources (optionally as a service) over a network. For example, computer system 200 could be used to select or render virtual content, collect or process sensor data, control lights and/or cameras, and/or perform other tasks within immersive content production system 100.

As shown, computer system 200 includes, without limitation, a central processing unit (CPU) 202 and a system memory 204 coupled to one or more input devices 208, such as a keyboard, mouse, joystick, touchscreen, etc., and an input/output (I/O) bridge 207 that is configured to forward the input information to the CPU 202 for processing via a communication path 206 and a memory bridge 205. A switch 216 is configured to provide connections between the I/O bridge 207 and other components of computer system 200, such as a network adapter 218 and various add-in cards 220 and 221. Although two add-in cards 220 and 221 are illustrated, in some embodiments, computer system 200 may not include any add-in cards or may only include a single add-in card, or the system 200 may include more than two add-in cards.

I/O bridge 207 is coupled to a system disk 214 that may be configured to store content, applications, and/or data for use by the CPU 202 and parallel processing subsystem 212. In some embodiments, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to the I/O bridge 207 as well.

In various embodiments, memory bridge 205 may be a Northbridge chip, and the I/O bridge 207 may be a Southbridge chip. In addition, communication paths 206 and 213, as well as other communication paths within the system 200, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to a display device 210 that may be any conventional cathode ray tube, liquid crystal display, light-emitting diode display, or the like. In such embodiments, parallel processing subsystem 212 incorporates circuitry optimized for graphics and video processing, including, for example, video output circuitry. Such circuitry may be incorporated across one or more parallel processing units (PPUs) included within parallel processing subsystem 212. In other embodiments, parallel processing subsystem 212 incorporates circuitry optimized for general purpose and/or compute processing. Again, such circuitry may be incorporated across one or more PPUs included within the parallel processing subsystem 212 that are configured to perform such general purpose and/or compute operations. In yet other embodiments, the one or more PPUs included within parallel processing subsystem 212 may be configured to perform graphics processing, general purpose processing, and compute processing operations. System memory 204 may include at least one device driver configured to manage the processing operations of the one or more PPUs within the parallel processing subsystem 212.

In various embodiments, parallel processing subsystem 212 may be or include a graphics processing unit (GPU). In some embodiments, the parallel processing subsystem 212 is integrated with one or more of the other elements of FIG. 2 to form a single system. For example, parallel processing subsystem 212 may be integrated with the CPU 202 and other connection circuitry on a single chip to form a system on chip (SoC).

In one embodiment, CPU 202 is the master processor of computer system 200, controlling and coordinating operations of other system components. In one embodiment, CPU 202 issues commands that control the operation of PPUs. In some embodiments, communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. First, the functionality and components of the system can be distributed across one or more nodes of a distributed, virtual, and/or cloud computing system. Second, the connection topology, including the number and arrangement of bridges, the number of CPUs, and the number of parallel processing subsystems, may be modified as desired. For example, in some embodiments, system memory 204 could be connected to CPU 202 directly rather than through memory bridge 205, and other devices would communicate with system memory 204 via memory bridge 205 and CPU 202. In another example, parallel processing subsystem 212 may be connected to I/O bridge 207 or directly to CPU 202, rather than to memory bridge 205. In a third example, I/O bridge 207 and memory bridge 205 may be integrated into a single chip instead of existing as one or more discrete devices. Lastly, in certain embodiments, one or more components shown in FIG. 2 may not be present. For example, switch 216 could be eliminated, and network adapter 218 and add-in cards 220, 221 would connect directly to the I/O bridge 207.

In one or more embodiments, system memory 204 stores a user interface 228, a placement engine 230, and an operating system 250 on which user interface 228 and placement engine 230 run. Operating system 250 may be, e.g., Linux®, Microsoft Windows®, or macOS®.

In some embodiments, user interface 228 and placement engine 230 include functionality to perform flexible parameterization of arbitrary display surfaces for in-camera visual effects. The display surfaces include light emitting diode (LED) panels and/or other surfaces on which video content can be dynamically displayed or projected. The display surfaces can be arranged within a layout of a 3D space, such as (but not limited to) a sound stage, set, AR environment, VR environment, MR environment, indoor space, and/or outdoor space. For example, the display surfaces could include one or more surfaces of displays 104 in immersive content production system 100.

More specifically, user interface 228 and placement engine 230 use configurable mappings between the display surfaces and two-dimensional (2D) regions representing parameterizations of the display surfaces to simplify the process of placing light cards and/or other graphical elements within the virtual environment depicted in the display surfaces. Each mapping includes information that can be used to convert between 3D spatial attributes of a graphical element on a display surface and a 2D representation of the graphical element within a region representing the display surface. For example, a mapping could include a 2D rectangular region representing a wall, ceiling, and/or another panel on which virtual content can be displayed. The mapping could also include one or more function that convert between a 2D position and orientation in the rectangular region to a 3D position, normal, and/or tangent on the panel.

User interface 228 can display a visualization of a 2D region from a mapping and allow a user to select a specific location for a graphical element within the 2D region. Placement engine 230 can use the mapping to convert the selected location into 3D attributes that are used to place and/or render a graphical element on the display surface. User interface 228 can also be updated with a representation of the graphical element. The user can also interact with user interface 228 to specify additional user inputs related to the orientation, shape, color, transparency, size, and/or other visual attributes of the graphical element. These additional user inputs can then be used to update the appearance of the graphical element on the display surface and within the visualization. Thus, unlike prior approaches, user interface 228 and placement engine 230 provide “what you see is what you get” (WYSIWYG) functionality to the user placing the graphical element on the display surface. The operation of user interface 228 and placement engine 230 is described in further detail below.

### Flexible Parameterization of Arbitrary Display Surfaces for In-Camera Visual Effects

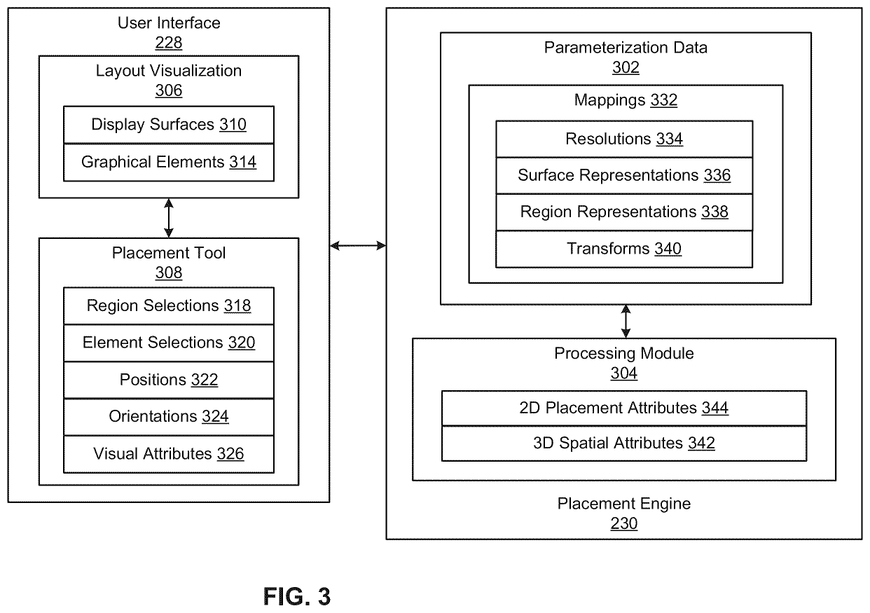

FIG. 3 is a more detailed illustration of user interface 228 and placement engine 230 of FIG. 2, according to various embodiments. As shown in FIG. 3, user interface 228 includes a layout visualization 306 and a placement tool 308 with which a user can interact to place graphical elements 314 on display surfaces 310 within a physical and/or virtual 3D space.

In some embodiments, user interface 228 is used to add graphical elements 314 to one or more displays 104 on which display surfaces 310 reside. These graphical elements 314 can include light cards, virtual green screens (e.g., regions of green and/or other uniform colors), virtual objects (e.g., objects depicted within a virtual environment), color correction windows, and/or other types of visual elements that can be used to adjust or define the lighting, background, foreground, color, and/or other components of a performance or scene in a media production.

User interface 228 can also, or instead, be used to select, place, animate, and/or move virtual objects, lights, and/or other content within a virtual reality (VR), augmented reality (AR), and/or mixed reality (MR) environment. This content can depict virtual worlds that can be experienced by any number of users synchronously and persistently, while providing continuity of data such as (but not limited to) personal identity, user history, entitlements, possession, and/or payments. It is noted that this content can include a hybrid of traditional audiovisual content and fully immersive VR, AR, and/or MR experiences, such as interactive video.

Additionally, user interface 228 can be used with a variety of computing devices and/or I/O devices. For example, user interface 228 could be generated by an application running on a tablet computer and/or another type of computing device with a touch-sensitive display and/or trackpad to allow a user to place graphical elements 314 on display surfaces 310 using touch input. User interface 228 could also, or instead, accept voice input, cursor input, joystick input, game controller input, pointing device input, wearable device input, stylus input, keyboard input, gestures, head movement, eye movement, and/or other types of input that can be generated by a user.

In some embodiments, layout visualization 306 includes a 3D layout of display surfaces 310 within a 3D space. For example, layout visualization 306 could include a view of a 3D model of display surfaces 310 within a sound stage. Within the view of the 3D model, color coding, shading, patterning, and/or other visual indicators could be used to distinguish between different display surfaces 310. A user could interact with the 3D model to change the position, orientation, direction, zoom, field of view, and/or other parameters that control the appearance of the 3D model within the view.

Layout visualization 306 also includes depictions of graphical elements 314 placed on display surfaces 310. Continuing with the above example, layout visualization 306 could include shapes, icons, and/or other representations of light cards, virtual green screens, virtual objects, color-correction windows, and/or other types of graphical elements 314 at the respective locations on display surfaces 310.

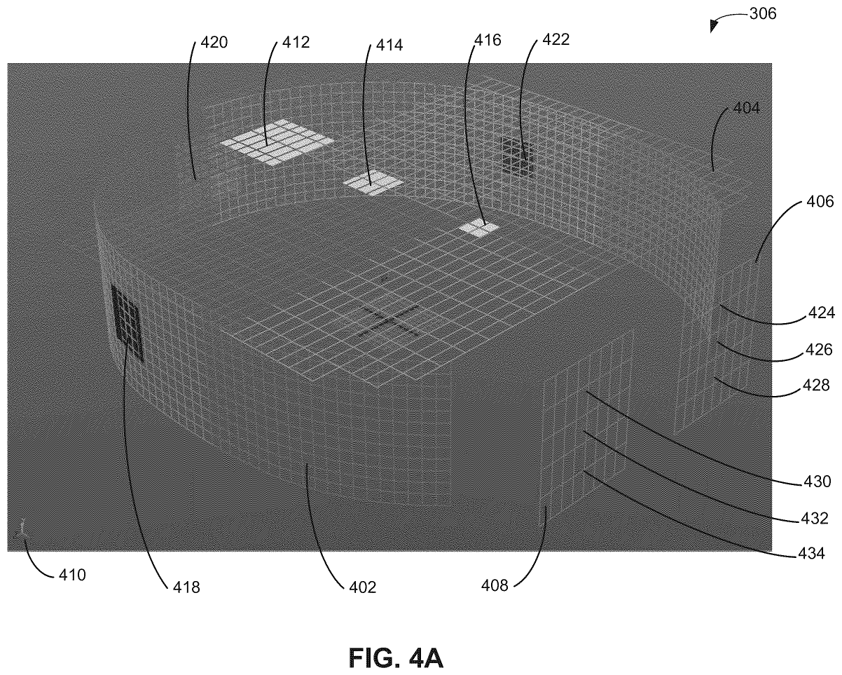

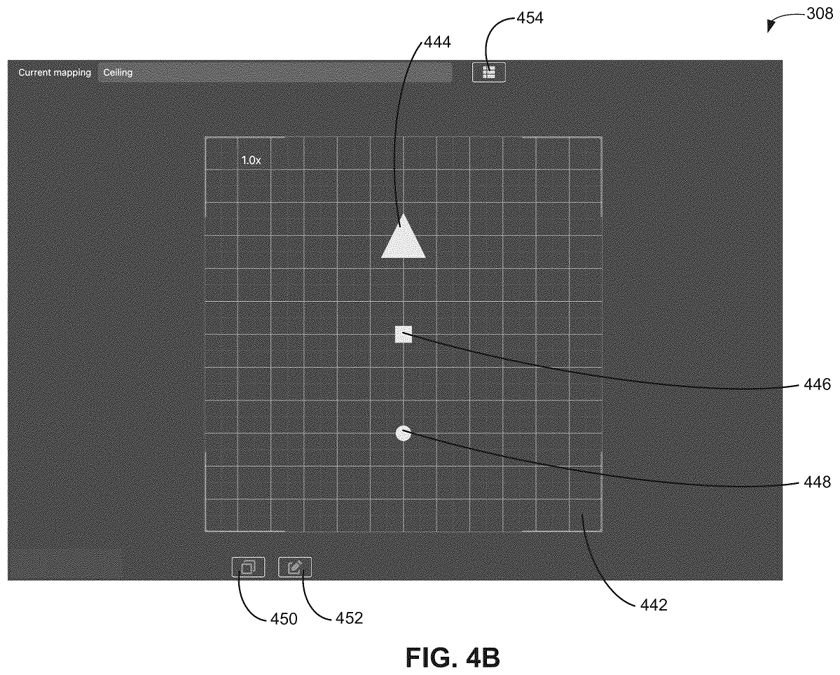

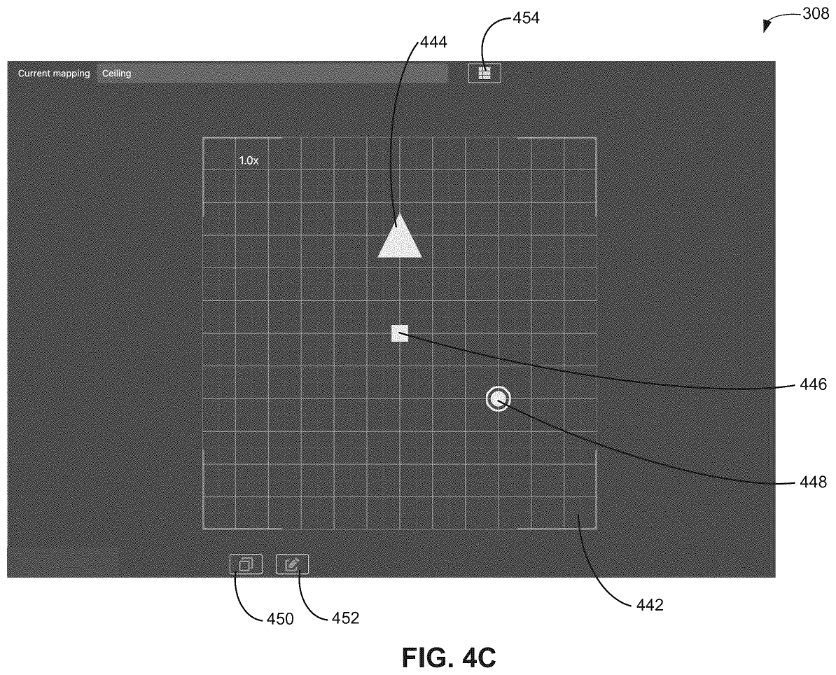

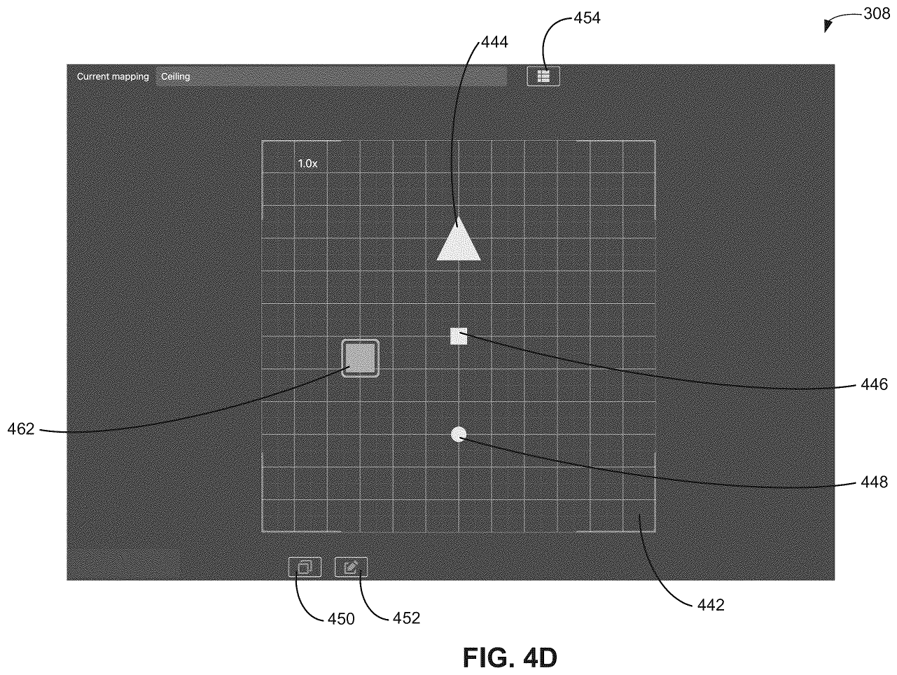

FIG. 4A illustrates an example layout visualization 306 provided by user interface 228 of FIG. 2, according to various embodiments. The example layout visualization 306 can be displayed within a touchscreen and/or another type of computer display. The example visualization 306 can also, or instead, be displayed within a VR, AR, and/or MR environment using a head-mounted display.

As shown in FIG. 4A, the example layout visualization 306 includes an arrangement of four display surfaces 402, 404, 406, and 408 within a 3D space. For example, layout visualization 306 could include a perspective view of multiple displays 104 arranged within a physical space that is used to generate a virtual environment (e.g., a sound stage, set, etc.). Within this physical space, display surface 402 could correspond to a wall that wraps around a significant portion of the space, display surface 404 could correspond to a ceiling, and each of display surfaces 406 and 408 could correspond to a different movable “door.”

Within the example layout visualization 306 of FIG. 4A, portions of one or more display surfaces 402, 404, 406, and/or 408 are shown in different colors to represent the subdivision of these display surface(s) into additional components. For example, display surface 402 could be shown as a horizontal sequence of rectangular regions with different colors to indicate the positions and sizes of corresponding displays (e.g., displays 104 of FIG. 1) that form display surface 402. Similarly, display surface 404 could be shown as a 2 by 3 grid of substantially rectangular regions to indicate the positions and sizes of corresponding displays that form display surface 404. On the other hand, each of display surfaces 406 and 408 could be shown as a rectangular region in a single color to indicate that the display surface is composed of a single display.

The example layout visualization 306 of FIG. 4A also includes a number of graphical elements 412, 414, 416, 418, 420, 422, 424, 426, 428, 430, 432, and 434 on display surfaces 402, 404, 406, and 408. More specifically, the example layout visualization 306 shows three graphical elements 412, 414, and 416 on display surface 404, three graphical elements 418, 420, and 422 on display surface 402, three graphical elements 424, 426, and 428 on display surface 406, and three graphical elements 430, 432, and 434 on display surface 408.

As mentioned above, graphical elements 412, 414, 416, 418, 420, 422, 424, 426, 428, 430, 432, and 434 can include (but are not limited to) light cards, virtual objects, virtual green screens, color-correction windows, and/or other types of visual content that can be individually placed and manipulated within display surfaces 402, 404, 406, and 408. A user can interact with placement tool 308 to change the position, orientation, color, shape, texture, brightness, and/or other attributes of each graphical element 412, 414, 416, 418, 420, 422, 424, 426, 428, 430, 432, and 434, as described in further detail below.

The example layout visualization 306 of FIG. 4A additionally includes a set of reference axes 410 associated with the perspective view. A user can provide touch input, gestures, cursor input, and/or other types of input to user interface 228 to view display surfaces 402, 404, 406, and 408 from different camera positions, orientations, fields of view, levels of zoom, and/or other parameters that affect the appearance of display surfaces 402, 404, 406, and 408 within layout visualization 306. As the view is updated within layout visualization 306, reference axes 410 are also updated to provide a frame of reference for the arrangement of display surfaces 402, 404, 406, and 408 within the view.

In some embodiments, the example layout visualization 306 of FIG. 4A additionally includes a side bar or area (not shown) that lists various components within the physical space and/or virtual environment. These components can include “lightCard” objects representing graphical elements 412, 414, 416, 418, 420, 422, 424, 426, 428, 430, 432, and 434. These components can also include “sticker” objects representing virtual objects (not shown) that can also be placed within display surfaces 402, 404, 406, and 408. Each light card, sticker, and/or other graphical element is additionally associated with a “Map” object that can be used to convert between a 2D parameterized representation of the graphical element and a set of 3D attributes that can be used to render the graphical element on one or more display surfaces 402, 404, 406, and/or 408. These components can additionally include “map2d” objects that represent mappings between display surfaces 402, 404, 406, and 408 in the physical space and 2D regions that parameterize positions, orientations, and/or other spatial attributes on display surfaces 402, 404, 406, and 408. A user can select an item within the list to view, edit, and/or otherwise interact with the corresponding object.

Returning to the discussion of FIG. 3, placement tool 308 includes user-interface elements that allow a user to specify parameters related to the placement of graphical elements 314 on display surfaces 310. These parameters include region selections 318, element selections 320, positions 322, orientations 324, and/or visual attributes 326 associated with the placements.

Region selections 318 include selections of 2D regions into which display surfaces 310 are parameterized. A user can make region selections 318 by selecting individual regions within a list provided by user interface 228, clicking on individual display surfaces 310 or portions of display surfaces 310 within layout visualization 306, and/or otherwise interacting with user interface 228.

Element selections 320 include selections of existing graphical elements 314 on display surfaces 310 and/or new graphical elements 314 to be added to display surfaces 310. For example, a user could select an existing graphical element by clicking on the element within layout visualization 306, a list of graphical elements 314, and/or another user-interface element provided by user interface 228. A user could also, or instead, create and place new graphical elements 314 on corresponding display surfaces 310 by making region selections 318 for the new graphical elements 314 and specifying positions 322, orientations 324, and visual attributes 326 of the new graphical elements 314, as described in further detail below.

Positions 322 include locations of graphical elements 314 within display surfaces 310. For example, positions 322 could be specified as 2D coordinates within regions into which display surfaces 310 are parameterized. A user could set and/or update the position of a given graphical element by clicking or tapping a representation of the graphical element within a region, clicking or tapping on a location within the region, and/or dragging the representation to a location within the region.

Orientations 324 include rotational attributes of graphical elements 314. In some embodiments, each of orientations 324 is defined with respect to a 2D frame of reference for a region into which a given display surface is parameterized. For example, the orientation of a graphical element within a display surface could be defined as a rotation about an XY reference frame for the region into which the display surface is parameterized.

Visual attributes 326 include parameters that affect the appearances of graphical elements 314 on display surfaces 310. For example, visual attributes 326 could include (but are not limited to) a size (e.g., height, width, depth, etc.), shape (e.g., circle, square, triangle, rectangle, polygon, etc.), color, transparency, saturation, contrast, intensity, brightness, texture, temperature, and/or color correction associated with a given graphical element. Placement tool 308 is described in further detail below with respect to FIGS. 4B-4D.

FIG. 4B illustrates an example screenshot of placement tool 308 provided by user interface 228 of FIG. 2, according to various embodiments. The screenshot includes a 2D region 442 representing display surface 404 from the example layout visualization 306 of FIG. 4A. The screenshot specifies that region 442 is associated with a mapping with a name of “Ceiling.”

The screenshot of FIG. 4B additionally shows three graphical elements 444, 446, and 448 within region 442, which correspond to graphical elements 412, 414, and 416, respectively, from the example layout visualization 306 of FIG. 4A. As shown in FIG. 4B, graphical element 444 has a triangular shape and is larger than graphical elements 446 and 448, graphical element 446 has a square shape and is larger than graphical element 448, and graphical element 448 has a circular shape and is smaller than graphical elements 444 and 446. All three graphical elements 444, 446, and 448 have the same yellow color.

The screenshot of FIG. 4B includes a user-interface element 454 that can be selected to change the region shown in placement tool 308. For example, a user could select user-interface element 454 to access a list of regions into which display surfaces 402, 404, 406, and 408 are parameterized. The user could select a region from the list to view a representation of the region and any graphical elements placed within the region within placement tool 308. The user could also, or instead, change the region displayed in placement tool 308 by selecting a corresponding display surface and/or portion of a display surface within layout visualization 306.

A user can interact with placement tool 308 to update the location of each graphical element 444, 446, and/or 448 and/or place new graphical elements in the display surface represented by region 442. For example, the user could select a graphical element in region 442 by clicking, tapping, “grabbing,” and/or otherwise interacting with the graphical element. The user could move the graphical element by dragging the selected graphical element within region 442, as described in further detail below with respect to FIG. 4C.

The screenshot of FIG. 4B also includes a user-interface element 450 that allows a given graphical element to be moved to another display surface. For example, the user could select a graphical element within the currently displayed region 442 and select user-interface element 450 to access a list of regions into which display surfaces 402, 404, 406, and 408 are parameterized. The user could select a different region from the list to move the selected graphical element from the currently displayed region 442 to the selected region, as described in further detail below with respect to FIG. 4D.

The screenshot of FIG. 4B additionally includes a user-interface element 452 that can be selected to specify visual attributes 326 of a given graphical element. For example, a user could select user-interface element 452 to access a screen of user interface 228 that includes sliders, dials, buttons, switches, and/or other user-interface elements that can be used to change the size, shape, color, transparency, saturation, contrast, intensity, brightness, texture, temperature, color correction, and/or other attributes associated with the appearance of the graphical element.

The screenshot of FIG. 4B also indicates a zoom of 1.0× for the depicted region 442. A user could use a pinch gesture, keyboard shortcut, cursor input, slider, and/or another type of input to increase or decrease the level of zoom in placement tool 308. For example, the user could zoom in to a particular part of region 442 to increase the level of granularity and/or precision with which a graphical element is placed within that part of region 442.

FIG. 4C illustrates an example screenshot of placement tool 308 provided by user interface 228 of FIG. 2, according to various embodiments. More specifically, FIG. 4C shows placement tool 308 after graphical element 448 has been selected and moved to a new location. As shown in FIG. 4C, graphical element 448 includes a yellow outline to indicate that graphical element 448 has been selected. Graphical element 448 is also shown to the right of and slightly above the previous position of graphical element 448 in FIG. 4B. A user can move graphical element 448 from the old location shown in FIG. 4B to the new location shown in FIG. 4C by selecting graphical element 448 and dragging graphical element 448 from the old location to the new location. As graphical element 448 is dragged from the old location to the new location within placement tool 308, placement engine 230 periodically converts each “current” location of graphical element 448 to a position on the corresponding display surface 404 and uses the position on display surface 404 to cause graphical element 448 to be placed at the position, as described in further detail below.

FIG. 4D illustrates an example screenshot of placement tool 308 provided by user interface 228 of FIG. 2, according to various embodiments. In particular, FIG. 4D shows placement tool 308 after a new graphical element 462 has been added to region 442.

For example, graphical element 462 could correspond to graphical element 420 from the example layout visualization 306 of FIG. 4A. A user could move graphical element 462 from a “Walls” region to the “Ceilings” region by navigating to the “Walls” region via user-interface element 454, selecting graphical element 462 within the displayed “Walls” region, and selecting the “Ceilings” region using user-interface element 450.

In another example, graphical element 462 could correspond to a newly created graphical element that is added to region 442. A user could create graphical element 462 by clicking on user-interface element 452 without first selecting an existing graphical element (e.g., graphical element 444, 446, or 448) in region 442. The user could also, or instead, create graphical element 462 by clicking on a different button and/or other type of user-interface element (not shown) that is dedicated to adding new graphical elements to the currently displayed region 442. The user could use the screen accessed via user-interface element 452 to specify visual attributes of graphical element 462 before adding graphical element 462 to region 442.

In both examples, graphical element 462 can be placed in an initial “default” location within region 442, such as (but not limited to) the middle of region 442. Graphical element 462 can then be selected and dragged to the location shown in FIG. 4D and/or other locations in region 442 using placement tool 308.

While the functionality of the example user interface 228 of FIGS. 4A-4D has been described above with respect to defining and manipulating individual graphical elements via various inputs and/or user-interface elements, it will be appreciated that user interface 228 can be implemented in a variety of ways. For example, user interface 228 could support the selection of multiple graphical elements (e.g., via long presses and/or other gestures or inputs) so that the positions, orientations, and/or visual attributes of the selected graphical elements can be updated as a group. In another example, user interface 228 could support the “locking” of movement and/or rotation of a given graphical element or group of graphical elements along one or more axes, so that the graphical element(s) can only be moved along and/or rotated about remaining “unlocked” axes. This axis-based locking can increase the precision with which the graphical element(s) are placed and/or rotated by mitigating shaking caused by wobbling of a finger, stylus, and/or another type of user input used to specify the placement and/or rotation. In a third example, user interface 228 could include additional user-interface elements that display information such as (but not limited to) identifiers, visual attributes, and/or other information related to one or more currently selected graphical elements.

Returning to the discussion of FIG. 3, a processing module 304 in placement engine 230 uses parameterization data 302 associated with display surfaces 310 to convert 2D placement attributes 344 for graphical elements 314 into 3D spatial attributes 342 of graphical elements 314 that can be used to display graphical elements 314 on the corresponding display surfaces 310. As shown in FIG. 3, parameterization data 302 includes a set of mappings 332 between display surfaces 310 in a 3D space and 2D regions into which display surfaces 310 are parameterized.

In one or more embodiments, mappings 332 are associated with a specific layout of display surfaces 310 within the 3D space. For example, mappings 332 could be generated and/or defined for an arrangement of display surfaces 310 that is used to depict a scene in a movie, television show, and/or another type of media program.

More specifically, mappings 332 include resolutions 334, surface representations 336, region representations 338, and transforms 340. Resolutions 334 include pixel dimensions for display surfaces 310 represented by individual 2D regions. For example, a resolution associated with a rectangular 2D region that parameterizes a horizontal sequence of N contiguous display surfaces 310 that form an LED wall in a sound stage could include a horizontal resolution of X*N and a vertical resolution of Y, where X is the width in pixels of each display surface and Y is the height in pixels of each display surface.

Resolutions 334 can also, or instead, include dimensions associated with the 2D regions. For example, resolutions 334 could include a horizontal resolution and a vertical resolution for a rectangular 2D region representing a wall, ceiling, door, and/or another rectangular arrangement of display surfaces. The horizontal resolution could represent a discrete number of horizontal positions 322 within the rectangular 2D region, and the vertical resolution could represent a discrete number of vertical positions 322 within the rectangular 2D region.

Surface representations 336 include spatial representations of display surfaces 310. For example, surface representations 336 could include 3D positions, orientations, and/or dimensions of each display surface, as determined with respect to a set of reference axes (e.g., reference axes 410 of FIG. 4A) in a 3D “world” space (e.g., a set, sound stage, physical pace, virtual space, indoor space, outdoor space, etc.) within which display surfaces 310 are arranged.

Region representations 338 include spatial representations of 2D regions into which display surfaces 310 are parameterized. For example, region representations 338 could include shapes, dimensions, positions, and/or orientations of rectangular, spherical, circular, and/or other 2D parameterized regions that can be used to map to corresponding 3D locations on display surfaces 310.

Transforms 340 include functions that can be used to convert between positions 322, orientations 324, visual attributes 326, and/or other 2D placement attributes 344 associated with graphical elements 314 in the 2D regions and corresponding positions, orientations, and/or other 3D spatial attributes 342 that can be used to place graphical elements 314 on display surfaces 310 in the 3D world space. For example, transforms 340 could include matrices, equations, and/or other components that convert a 2D position and orientation on a 2D region, as specified by a user interacting with placement tool 308, into a position, orientation, tangent, normal, and/or another 3D attribute on a corresponding display surface and/or a virtual environment depicted on the display surface.

In one or more embodiments, parameterization data 302 includes advanced controls that can be used to control the way in which 2D coordinates in the 2D regions (denoted by S and T) can be used to parameterize the corresponding display surfaces 310. For example, a parameterization for a rectangular display surface (e.g., a wall) could include minimum S and T values that are both set to 0, maximum S and T values that are both set to 1, and “default” S and T values that are both set to 0.5 for graphical elements 314 that are newly added to the display surface. In another example, a latitude-longitude parameterization could include a minimum S value of −180, a maximum S value of 180, a minimum T value of 0, a maximum T value of 90, a default S value of 270, and a default T value of 25. These minimum, maximum, and default ST values allow the latitude-longitude parameterization to include S values representing angles that range from −180 to 180 and T values representing angles that range from 0 to 90. The minimum and maximum S values can also be wrapped to include values that range from 0 to 360.

In one or more embodiments, processing module 304 uses input received via placement tool 308 and parameterization data 302 to place graphical elements 314 on display surfaces 310. More specifically, processing modules 304 receives, from user interface 228, 2D placement attributes 344 that include (but are not limited to) region selections 318, element selections 320, positions 322, orientations 324, and/or visual attributes 326 associated with individual graphical elements 314. Processing module 304 uses transforms 340 to convert 2D positions 322 and orientations 324 of the portion of a 2D region occupied by a given graphical element into corresponding 3D positions, tangents, and/or normals on one or more display surfaces 310. Processing module 304 then outputs pixel values, pixel locations, “world space” locations, vectors, and/or other 3D spatial attributes 342 of the graphical element to cause the graphical element to be placed on the display surface(s).

As updates to 2D placement attributes 344 for a given graphical element are received from user interface 228, processing module 304 converts these 2D placement attributes 344 into new 3D spatial attributes 342 of the graphical element and outputs the new 3D spatial attributes 342 and/or other data that can be used to update the appearance of the graphical element in the display surface(s). For example, processing module 304 could compute and generate output that causes the graphical element to move across the display surface(s) in response to a user dragging his/her finger across a representation of the 2D regions into which the display surface(s) are parameterized within user interface 228. In another example, processing module 304 could change the orientation, shape, color, texture, brightness, transparency, saturation, contrast, intensity, and/or other attributes of a graphical element in response to changes received via placement tool 308.

As 3D spatial attributes 342 are used to place, rotate, and/or edit the graphical element on the display surface(s), user interface 228 is updated to indicate the current position, orientation, and/or visual attributes 326 of the graphical element within layout visualization 306 and/or one or more 2D regions into which the display surface(s) are parameterized. Consequently, user interface 228 allows graphical elements 314 to be placed on display surfaces 310 in an intuitive WYSIWYG manner.

As mentioned above, 3D spatial attributes 342 can include values that inform the placement of a given graphical element in a 3D space associated with display surfaces 310. For example, 3D spatial attributes 342 could define the position, tangent, and normal of the graphical element on a display surface within a 3D world space occupied by a layout of display surfaces 310 within a sound stage, set, and/or another type of performance area 102.

In some embodiments, 3D spatial attributes 342 are also, or instead, defined with respect to a 3D space associated with a virtual environment depicted on some or all display surfaces 310. For example, the virtual environment could include a 3D virtual world that serves as a background for a scene associated with a performance in performance area 102. In this example, instead of converting 2D placement attributes 344 of a graphical object into 3D spatial attributes 342 that are defined with respect to a 3D layout of display surfaces 310, placement engine 230 could convert 2D placement attributes 344 of the graphical object into 3D spatial attributes 342 that represent the position and orientation of the graphical object on a virtual surface (e.g., a wall, floor, ceiling, object, etc.) within the virtual world and/or at a certain depth within the virtual world that is defined relative to the position on a display surface in which the graphical object is to appear. In other words, the graphical object could be placed on display surfaces 310 so that the graphical object appears at that position on the display surface and at a certain orientation and/or depth that is defined with respect to a virtual surface at that position within the virtual world and/or a 3D coordinate system for the virtual world. As the perspective associated with the virtual background is updated (e.g., in response to a change in perspective associated with one or more cameras capturing the performance), 3D spatial attributes 342 of the graphical object could be updated so that the graphical object continues to be displayed at the same position and orientation within the 3D space of the virtual world. Further, as a user interacts with user interface 228 to move the graphical object within a 2D region parameterizing a given display surface, 3D spatial attributes 342 of the graphical object could be computed so that the graphical object appears to be moving within the virtual world (e.g., along, in front of, or behind surfaces of the virtual world depicted at positions on the display surface corresponding to locations within the 2D region, along a fixed distance to a camera or performer within the 3D space of the virtual world, etc.).

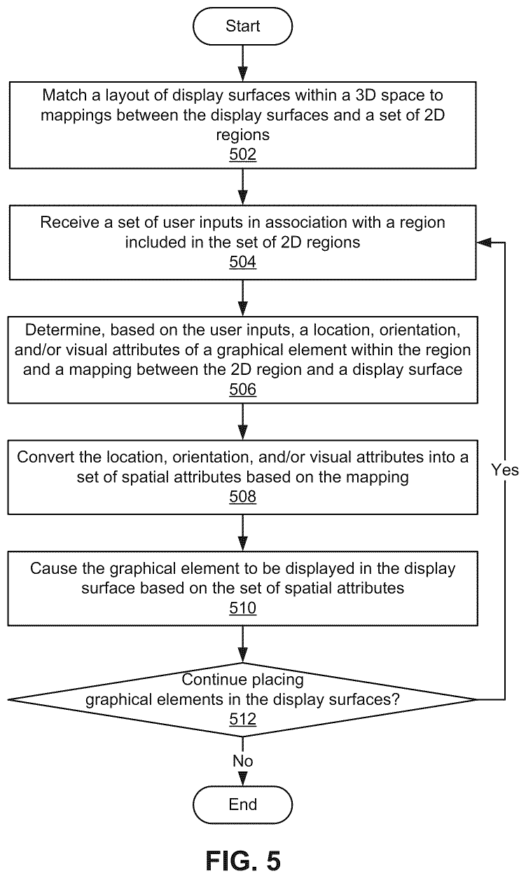

FIG. 5 sets forth a flow diagram of method steps for generating in-camera effects using parameterizations of display surfaces, according to various embodiments. Although the method steps are described in conjunction with the systems of FIGS. 1-4, persons skilled in the art will understand that any system configured to perform some or all of the method steps in any order falls within the scope of the present disclosure.

As shown, in step 502, placement engine 230 matches a layout of display surfaces within a 3D space to mappings between the display surfaces and a set of 2D regions. For example, placement engine 230 could retrieve a “top-level” object and/or file representing the layout of display surfaces within a sound stage and/or another physical or virtual 3D space. Placement engine 230 could also retrieve a grouping of files and/or objects representing the mappings under the top-level object and/or file. Placement engine 230 could then use the grouping of files and/or objects to access parameterization data for the mappings.

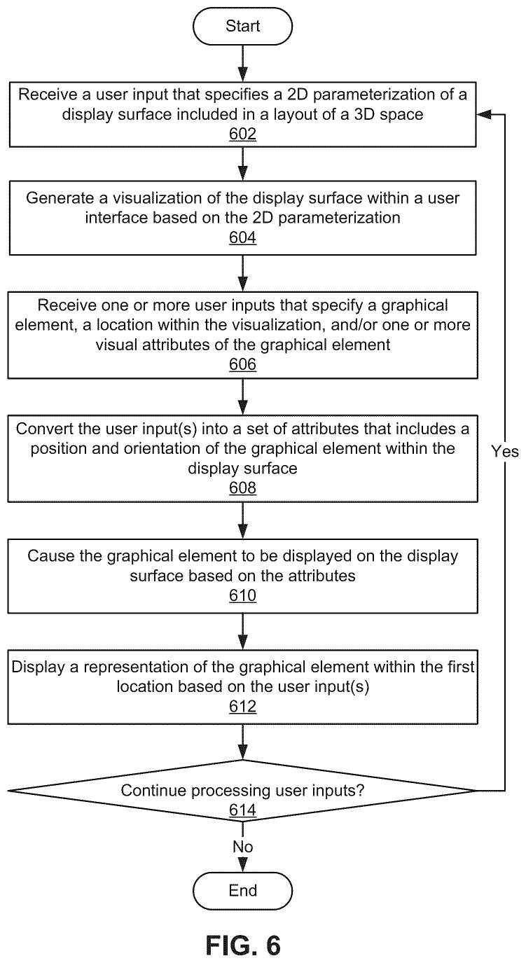

In step 504, placement engine 230 receives a set of user inputs in association with a region included in the set of 2D regions. For example, placement engine 230 could receive the user inputs via a user interface that includes a visualization of the layout and/or individual display surfaces within the layout, as described in further detail below with respect to FIG. 6.

In step 506, placement engine 230 determines, based on the user inputs, a location, orientation, and/or visual attributes of a graphical element within the region and a mapping between the 2D region and a display surface. For example, placement engine 230 could match one or more user inputs to the region and/or the graphical element and determine a mapping between the region and a corresponding display surface. Placement engine 230 could also, or instead, determine a location, orientation, size, shape, color, transparency, saturation, contrast, intensity, brightness, texture, temperature, and/or color correction for the graphical element based on one or more user inputs.

In step 508, placement engine 230 converts the location, orientation, and/or visual attributes into a set of spatial attributes based on the mapping. For example, placement engine 230 could retrieve one or more transforms from the mapping and use the transform(s) to convert a 2D representation of the position, orientation, and/or visual attributes of the graphical element into 3D spatial attributes that are specified with respect to a reference frame for the layout, the display surface, and/or a virtual world depicted on the display surface.

In step 510, placement engine 230 causes the graphical element to be displayed in the display surface based on the set of spatial attributes. For example, placement engine 230 could transmit the spatial attributes to one or more downstream components. The downstream components could generate additional signals and/or outputs that effect the display of the display element on the display surface using the corresponding position, orientation, and/or visual attributes.

In step 512, placement engine 230 determines whether or not to continue placing graphical elements in the display surfaces. For example, placement engine 230 could determine that graphical elements should continue to be placed in the display surfaces during the generation of in-camera visual effects, an AR/MR/VR environment, and/or other types of effects or environments using the layout of display surfaces.

If placement engine 230 determines that display of graphical elements in the display surfaces is to continue, placement engine 230 repeats steps 504, 506, 508, and 510 to update the locations, orientations, and/or visual attributes of existing graphical elements within the display surfaces and/or to add new graphical elements to the display surfaces. Placement engine 230 also repeats step 512 to determine whether or not to continue placing graphical elements in the display surfaces. Once placement engine 230 determines that graphical elements are no longer to be placed in the display surfaces (e.g., after visual effects and/or environments that include the graphical elements are no longer generated using the layout of display surfaces), placement engine 230 stops performing steps 504, 506, 508, 510, and 512.

FIG. 6 sets forth a flow diagram of method steps for placing graphical elements on display surfaces via user interface 228, according to various embodiments. Although the method steps are described in conjunction with the systems of FIGS. 1-4, persons skilled in the art will understand that any system configured to perform some or all of the method steps in any order falls within the scope of the present disclosure.

As shown, in step 602, user interface 228 receives a user input that specifies a 2D parameterization of a display surface included in a layout of a 3D space. For example, user interface 228 could receive the user input as a selection of the display surface within a visualization of a layout of multiple display surfaces within a 3D space. User interface 228 could also, or instead, receive the user input as a selection of a name and/or another representation of the display surface and/or 2D parameterization within a list, drop-down menu, and/or another user-interface element. The 2D parameterization could convert positions, tangents, normals, and/or other 3D spatial attributes on the display surface into corresponding 2D attributes within an “ST” space, where S denotes a horizontal dimension and T denotes a vertical dimension. The 2D parameterization could also, or instead, convert the 3D spatial attributes into corresponding 2D attributes within a spherical coordinate space, where the spherical coordinate space includes a first coordinate (e.g., a latitude) that specifies a vertical position on a sphere and a second coordinate (e.g., a longitude) that specifies a horizontal position on the sphere.

In step 604, user interface 228 generates a visualization of the display surface within a user interface based on the 2D parameterization. For example, user interface 228 could generate a visualization of a 2D rectangular and/or spherical region into which a curved, planar, and/or another type of display surface is parameterized.

In step 606, user interface 228 receives one or more user inputs that specify a graphical element, a location within the visualization, and/or one or more visual attributes of the graphical element. For example, user interface 228 could receive user inputs that define a new graphical element to be placed in the display surface, select an existing graphical element that is already placed on the display surface, select a location within a 2D region, and/or zoom in to or out of a given portion of the visualization. User interface 228 could also, or instead, receive user inputs that specify the location, orientation, size, shape, color, transparency, saturation, contrast, intensity, brightness, texture, temperature, and/or color correction for the graphical element. At least some of the user inputs can be specified in a WYSIWYG manner. For example, a user could specify a position of the graphical element within the display surface by tapping, clicking, directing a cursors to, and/or otherwise selecting a corresponding location within the visualization. In another example, the user could provide touch-based and/or other input that changes the orientation and/or other visual attributes of the graphical element within both the display surface and the visualization.

In step 608, user interface 228 converts the user input(s) into a set of attributes that includes a position and orientation of the graphical element within the display surface. For example, user interface 228 could convert the user input(s) into 2D locations, orientations, and/or visual attributes of the graphical element.

In step 610, user interface 228 causes the graphical element to be displayed on the display surface based on the attributes. Continuing with the above example, user interface 228 could provide the 2D values to placement engine 230, and placement engine 230 could use one or more transforms associated with the 2D parameterization to convert the 2D values into a set of 3D spatial attributes. Placement engine 230 could then provide the 3D spatial attributes to downstream components that generate output used to display the graphical element on the display surface, as discussed above.

In step 612, user interface 228 displays a representation of the graphical element within the first location based on the user input(s). For example, user interface 228 could update the visualization to include a representation of the location, orientation, and/or other attributes of the graphical element. The representation could also be generated in a WYSIWYG manner to facilitate accurate placement and/or display of the graphical element in the display surface and/or other display surfaces within the layout.

In step 614, user interface 228 determines whether or not to continue processing user inputs. For example, user interface 228 could continue processing user inputs while user interface 228 is executed to facilitate the placement of graphical objects on the display surfaces.

If user interface 228 determines that display of graphical elements in the display surfaces is to continue, user interface 228 repeats steps 602, 604, 606, 608, 610, and 612 to process additional user inputs for the purpose of updating locations, orientations, and/or visual attributes of an existing graphical element within the display surfaces and/or to add new graphical elements to the display surfaces. User interface 228 and/or a component providing user interface also repeats step 614 to determine whether or not to continue processing the user inputs. Once user interface 228 and/or the component determine that processing of user inputs is to be discontinued (e.g., after execution of user interface 228 is discontinued), user interface 228 stops performing steps 602, 604, 606, 608, 610, 612, and 614.

In sum, the disclosed techniques perform flexible parameterization of arbitrary display surfaces for in-camera (and/or other types of) visual effects. The display surfaces include LED panels and/or other surfaces on which video content can be dynamically displayed or projected. The display surfaces can be arranged within a layout of a 3D space, such as (but not limited to) a sound stage, set, AR environment, VR environment, MR environment, indoor space, and/or outdoor space.

More specifically, configurable mappings between the display surfaces and 2D regions representing parameterizations of the display surfaces are used to simplify the process of placing light cards, virtual green screens, color correction windows, virtual objects, and/or other graphical elements within the display surfaces. Each mapping includes information that can be used to convert between 3D attributes of a graphical element on a display surface and a 2D representation of the graphical element within a corresponding 2D region. For example, a mapping could include a 2D rectangular region representing a wall, ceiling, and/or another panel or grouping of panels on which visual content can be displayed. The mapping could also include one or more functions that convert between a 2D position and orientation in the rectangular region and a 3D position, normal, and/or tangent on the panel and/or a virtual world depicted on the panel.

A user interface can display a visualization of a 2D region from a mapping and allow a user to select a specific location for a graphical element within the 2D region. One or more transforms can be retrieved from the mapping and used to convert the selected location into a position, tangent, normal, and/or other 3D attributes associated with the corresponding display surface. The 3D attributes can then be used to render a graphical element on the display surface, and the selected location can be updated with a representation of the graphical element. The user can also interact with the user interface to specify additional user inputs related to the orientation, shape, color, transparency, size, and/or other visual attributes of the graphical element. These additional user inputs can be used to update the appearance of the graphical element on the display surface and the visualization.

One technical advantage of the disclosed techniques is the ability to subdivide and parameterize arbitrary numbers and arrangements of display surfaces within a 3D space into a number of discrete 2D regions. Accordingly, the disclosed techniques allow locations of graphical elements on the display surfaces to be specified in a precise and unambiguous manner. Another technical advantage of the disclosed techniques is the ability to select and update display surfaces on which the graphical elements are to be shown and locations of the graphical elements within the display surfaces via a WYSIWYG user interface. Consequently, the disclosed techniques can be used to generate in-camera visual effects and/or other types of 3D graphics more quickly, efficiently, and accurately than user interfaces that require counterintuitive abstractions of dimensions within a 3D space to place graphical elements within the 3D space. These technical advantages provide one or more technological improvements over prior art approaches.

1. In some embodiments, a computer-implemented method for placing graphical elements on display surfaces comprises generating a first visualization of a first display surface based on a first two-dimensional (2D) parameterization of the first display surface; receiving a first user input that specifies a first location within the first visualization; converting the first location into a second location within the first 2D parameterization; causing a first graphical element to be displayed at a third location on the first display surface based on the second location; and displaying, within the first visualization, a first representation of the first graphical element at the first location.

2. The computer-implemented method of clause 1, further comprising receiving a second user input that specifies the first 2D parameterization prior to generating the first visualization.

3. The computer-implemented method of any of clauses 1-2, wherein the second user input is received via a user interface that includes the first visualization.

4. The computer-implemented method of any of clauses 1-3, further comprising receiving a second user input that specifies the first graphical element prior to receiving the first user input.

5. The computer-implemented method of any of clauses 1-4, further comprising receiving a third user input that specifies a level of zoom related to the first visualization prior to receiving the second user input.

6. The computer-implemented method of any of clauses 1-5, wherein the second user input comprises a selection of a second representation of the first graphical element at a fourth location within the first visualization.

7. The computer-implemented method of any of clauses 1-6, further comprising receiving a second user input that specifies a set of visual attributes associated with the first graphical element; and causing the first graphical element to be displayed at the third location on the first display surface based on the set of visual attributes.

8. The computer-implemented method of any of clauses 1-7, wherein the set of visual attributes comprises at least one of a size, a color, a shape, a texture, a brightness, a transparency, a saturation, a contrast, an intensity, a temperature, a color correction, or an orientation.

9. The computer-implemented method of any of clauses 1-8, wherein causing the first graphical element to be displayed at the third location on the first display surface comprises determining a transform between the first 2D parameterization and a three-dimensional (3D) representation of the first display surface; and computing the third location using the second location within the first 2D parameterization and the transform.

10. The computer-implemented method of any of clauses 1-9, wherein the first user input comprises a touch input on a touchscreen within which the first visualization is displayed.

11. In some embodiments, one or more non-transitory computer-readable media store instructions that, when executed by one or more processors, cause the one or more processors to perform the steps of generating a first visualization of a first display surface based on a first two-dimensional (2D) parameterization of the first display surface; receiving a first user input that specifies a first location within the first visualization; converting the first location into a second location within the first 2D parameterization; causing a first graphical element to be displayed at a third location on the first display surface based on the second location; and displaying, within the first visualization, a representation of the first graphical element at the first location.

12. The one or more non-transitory computer-readable media of clause 11, wherein the instructions further cause the one or more processors to perform the step of receiving a second user input that specifies the first 2D parameterization and a third user input that specifies the first graphical element prior to receiving the first user input.

13. The one or more non-transitory computer-readable media of any of clauses 11-12, wherein the second user input and the third user input are received via a user interface that includes the first visualization.

14. The one or more non-transitory computer-readable media of any of clauses 11-13, wherein the instructions further cause the one or more processors to perform the step of receiving a second user input that specifies a level of zoom related to the first visualization prior to receiving the first user input.

15. The one or more non-transitory computer-readable media of any of clauses 11-14, wherein the instructions further cause the one or more processors to perform the steps of receiving a second user input that specifies a fourth location within a second visualization of a second display surface; causing the first graphical element to be displayed at a fifth location on the second display surface based on the fourth location and a second 2D parameterization of the second display surface; and displaying, within the second visualization, a second representation of the first graphical element at the fourth location.

16. The one or more non-transitory computer-readable media of any of clauses 11-15, wherein the first display surface and the second display surface are included in a sound stage.

17. The one or more non-transitory computer-readable media of any of clauses 11-16, wherein the instructions further cause the one or more processors to perform the steps of receiving a second user input that specifies a first orientation of the first graphical element within the first visualization; converting the first orientation into a second orientation on the first display surface; and causing the first graphical element to be displayed using the second orientation on the first display surface.

18. The one or more non-transitory computer-readable media of any of clauses 11-17, wherein causing the first graphical element to be displayed at the third location on the first display surface comprises converting the second location within the first 2D parameterization into a set of spatial attributes; and causing the first graphical element to be displayed on the first display surface based on the set of spatial attributes.

19. The one or more non-transitory computer-readable media of any of clauses 11-18, wherein the set of spatial attributes comprises a three-dimensional position corresponding to the third location, a normal, and a tangent.

20. In some embodiments, a system comprises one or more memories that store instructions, and one or more processors that are coupled to the one or more memories and, when executing the instructions, are configured to perform the steps of generating a first visualization of a first display surface based on a first two-dimensional (2D) parameterization of the first display surface; receiving a first user input that specifies a first location within the first visualization; converting the first location into a second location within the 2D parameterization; causing a first graphical element to be displayed at a third location on the first display surface based on the second location; and displaying, within the first visualization, a representation of the first graphical element at the first location.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for placing graphical elements on display surfaces, the method comprising:
generating a first visualization of a first display surface based on a first two-dimensional (2D) parameterization of the first display surface;
receiving a first user input that specifies a first location within the first visualization;
converting the first location into a second location within the first 2D parameterization;
causing a first graphical element to be displayed at a third location on the first display surface based on the second location; and
displaying, within the first visualization, a first representation of the first graphical element at the first location.

2. The computer-implemented method of claim 1, further comprising receiving a second user input that specifies the first 2D parameterization prior to generating the first visualization.

3. The computer-implemented method of claim 2, wherein the second user input is received via a user interface that includes the first visualization.

4. The computer-implemented method of claim 1, further comprising receiving a second user input that specifies the first graphical element prior to receiving the first user input.

5. The computer-implemented method of claim 4, further comprising receiving a third user input that specifies a level of zoom related to the first visualization prior to receiving the second user input.

6. The computer-implemented method of claim 4, wherein the second user input comprises a selection of a second representation of the first graphical element at a fourth location within the first visualization.

7. The computer-implemented method of claim 1, further comprising:
receiving a second user input that specifies a set of visual attributes associated with the first graphical element; and
causing the first graphical element to be displayed at the third location on the first display surface based on the set of visual attributes.

8. The computer-implemented method of claim 7, wherein the set of visual attributes comprises at least one of a size, a color, a shape, a texture, a brightness, a transparency, a saturation, a contrast, an intensity, a temperature, a color correction, or an orientation.

9. The computer-implemented method of claim 1, wherein causing the first graphical element to be displayed at the third location on the first display surface comprises:
determining a transform between the first 2D parameterization and a three-dimensional (3D) representation of the first display surface; and
computing the third location using the second location within the first 2D parameterization and the transform.

10. The computer-implemented method of claim 1, wherein the first user input comprises a touch input on a touchscreen within which the first visualization is displayed.

11. One or more non-transitory computer-readable media storing instructions that, when executed by one or more processors, cause the one or more processors to perform the steps of:
generating a first visualization of a first display surface based on a first two-dimensional (2D) parameterization of the first display surface;
receiving a first user input that specifies a first location within the first visualization;
converting the first location into a second location within the first 2D parameterization;
causing a first graphical element to be displayed at a third location on the first display surface based on the second location; and
displaying, within the first visualization, a representation of the first graphical element at the first location.

12. The one or more non-transitory computer-readable media of claim 11, wherein the instructions further cause the one or more processors to perform the step of receiving a second user input that specifies the first 2D parameterization and a third user input that specifies the first graphical element prior to receiving the first user input.

13. The one or more non-transitory computer-readable media of claim 12, wherein the second user input and the third user input are received via a user interface that includes the first visualization.

14. The one or more non-transitory computer-readable media of claim 11, wherein the instructions further cause the one or more processors to perform the step of receiving a second user input that specifies a level of zoom related to the first visualization prior to receiving the first user input.

15. The one or more non-transitory computer-readable media of claim 11, wherein the instructions further cause the one or more processors to perform the steps of:
receiving a second user input that specifies a fourth location within a second visualization of a second display surface;
causing the first graphical element to be displayed at a fifth location on the second display surface based on the fourth location and a second 2D parameterization of the second display surface; and
displaying, within the second visualization, a second representation of the first graphical element at the fourth location.

16. The one or more non-transitory computer-readable media of claim 15, wherein the first display surface and the second display surface are included in a sound stage.

17. The one or more non-transitory computer-readable media of claim 11, wherein the instructions further cause the one or more processors to perform the steps of:
receiving a second user input that specifies a first orientation of the first graphical element within the first visualization;
converting the first orientation into a second orientation on the first display surface; and
causing the first graphical element to be displayed using the second orientation on the first display surface.

18. The one or more non-transitory computer-readable media of claim 11, wherein causing the first graphical element to be displayed at the third location on the first display surface comprises:
converting the second location within the first 2D parameterization into a set of spatial attributes; and
causing the first graphical element to be displayed on the first display surface based on the set of spatial attributes.

19. The one or more non-transitory computer-readable media of claim 18, wherein the set of spatial attributes comprises a three-dimensional position corresponding to the third location, a normal, and a tangent.

20. A system, comprising:
one or more memories that store instructions, and
one or more processors that are coupled to the one or more memories and, when executing the instructions, are configured to perform the steps of:
generating a first visualization of a first display surface based on a first two-dimensional (2D) parameterization of the first display surface;
receiving a first user input that specifies a first location within the first visualization;
converting the first location into a second location within the 2D parameterization;
causing a first graphical element to be displayed at a third location on the first display surface based on the second location; and
displaying, within the first visualization, a representation of the first graphical element at the first location.
